(19) United States
(12) Patent Application Publication
(10) Pub. No.: US 2006/0183480 A1
(43) Pub. Date: Aug. 17, 2006

(54) Mobile communication system

(75) Inventors: Yasuhiro Kato, Yokohama-shi (JP); Hideaki Takahashi, Yokohama-shi (JP); Masayuki Motegi, Yokohama-shi (JP); Takehiro Nakamura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Chiyoda-ku (JP)

(21) Appl. No.: 11/339,547

(22) Filed: Jan. 26, 2006

(30) Foreign Application Priority Data
Jan. 26, 2005 (JP) 2005-018480

(51) Int. Cl. H04Q 7/20

(52) U.S. Cl. 455/436

(57) ABSTRACT

A mobile communication system for providing mobile communication service by radio to a mobile station is disclosed. The mobile communication system comprises base stations having a function of controlling hand-overs and in-coming and out-going calls necessary for providing the mobile communication service, and a multi-cell controlling station having a function of managing radio resources of plural base stations forming radio cells and selecting an optimum base station, and a function of allocating radio resources to the base stations. When at least one of the base station controls an in-coming or out-going call or controls a hand-over, if its own radio resource usage rate is lower than a threshold, the base station selects a base station to be allocated without communicating with the multi-cell controlling station.

### BACKGROUND OF THE INVENTION

The present invention generally relates to a mobile communication system for providing mobile communication service by radio to a mobile station.

In the prior art, the PDC (Personal Digital Cellular) system and the IMT-2000 (International Mobile Telecommunications-2000) are known, which are widely adapted as mobile communication systems. The conventional node architecture employed by these systems is also known. These mobile communication systems, referred to as cellular systems, have two dimensional service areas formed by a group of radio cells established by base stations.

From the viewpoint of efficient radio resource usage, it is desired to have an allocating function of adequately allocating radio resources to base stations in consideration of congestion, and a hand-over function of selecting an optimum base station for a mobile station. These inter-cell functions are desirably performed by an upper node, which upper node is separate from the base stations.

Therefore, these systems comprise base stations which can perform conversion between the wired link and the radio link, and a radio controlling station which performs mobile station radio control such as hand-over control and position registration control, and so on.

As mentioned above, in the prior art communication systems, the mobile station radio control function is performed by the radio controlling station. However, this arrangement has disadvantages in that the radio controlling station is needed and radio control delay is increased.

The inventors of the present invention found that the radio controlling station is not necessarily required especially for single (independent) cell architecture and for less congested environments.

The conventional radio controlling station having such a mobile station radio control function is located far away from the base stations, and therefore the radio control of the mobile stations is much delayed especially when the so-called entrance line between the radio controlling station and the base stations has narrow bandwidth or utilizes a satellite route. The increased delay in radio control lowers control efficiency and does not satisfy users' demands, and therefore avoiding the delay is desired.

### SUMMARY OF THE INVENTION

The present invention may provide a mobile communication system in which communication service can be given by base stations only and a multi-cell controlling station is used only when truly necessary, in order to avoid radio control delay.

In a preferred embodiment of the present invention is provided a mobile communication system for providing mobile communication service by radio to a mobile station, comprising base stations having a function of controlling hand-overs and in-coming and out-going calls necessary for providing the mobile communication service.

The mobile communication system may further comprise a multi-cell controlling station having a function of managing radio resources of plural base stations forming radio cells and selecting an optimum base station, and a function of allocating radio resources to the base stations. When at least one of the base stations controls an in-coming or out-going call or controls a hand-over, if its own radio resource usage rate is lower than a threshold, the base station may select a base station to be allocated without communicating with the multi-cell controlling station.

### BRIEF DESCRIPTION OF THE DRAWINGS

FIG. 1 shows the node architecture of a mobile communication system according to an embodiment of the present invention;

FIG. 2 is a block diagram of the base station 3 according to the embodiment of the present invention;

FIG. 3 is a block diagram of the multi-cell controlling station 4 according to the embodiment of the present invention;

FIG. 4 is a sequence chart illustrating procedures for a call and a hand-over without the multi-cell controlling station 4 according to the embodiment of the present invention;

FIG. 5 is a sequence chart illustrating a calling procedure and a hand-over procedure with the multi-cell controlling station 4 according to another embodiment of the present invention; and

FIG. 6 is a flowchart illustrating a procedure in the base station 3 when receiving a request for radio link establishment or a request for a hand-over according to further embodiment of the present invention.

### DESCRIPTION OF THE PREFERRED EMBODIMENTS

The following is a description of embodiments of the present invention, with reference to the accompanying drawings.

Throughout all the figures, members and parts having the same or similar functions are assigned the same or similar reference signs, and redundant explanations are omitted.

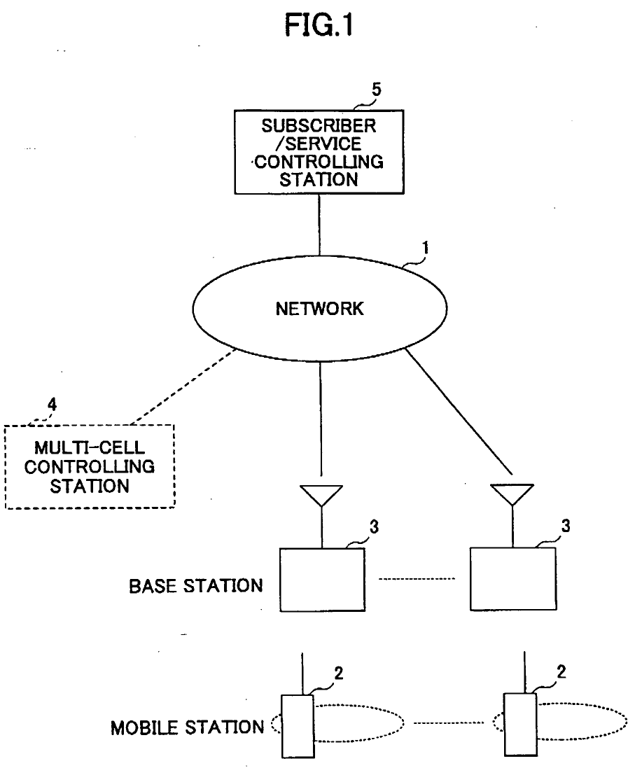

FIG. 1 shows node architecture of a mobile communication system according to an embodiment of the present invention. The mobile communication system shown in FIG. 1 comprises a core network 1, plural mobile stations 2, plural base stations 3, a multi-cell controlling station 4, and a subscriber/service controlling station 5.

The core network 1 may be a network using IP (Internet Protocol).

All layers from a physical layer to an application layer are terminated at the mobile station 2. The mobile station 2 has radio controlling functions for transmitting and receiving calls and performing hand-overs, and further has a selection function of selecting a base station 3 to communicate with at the request of the network.

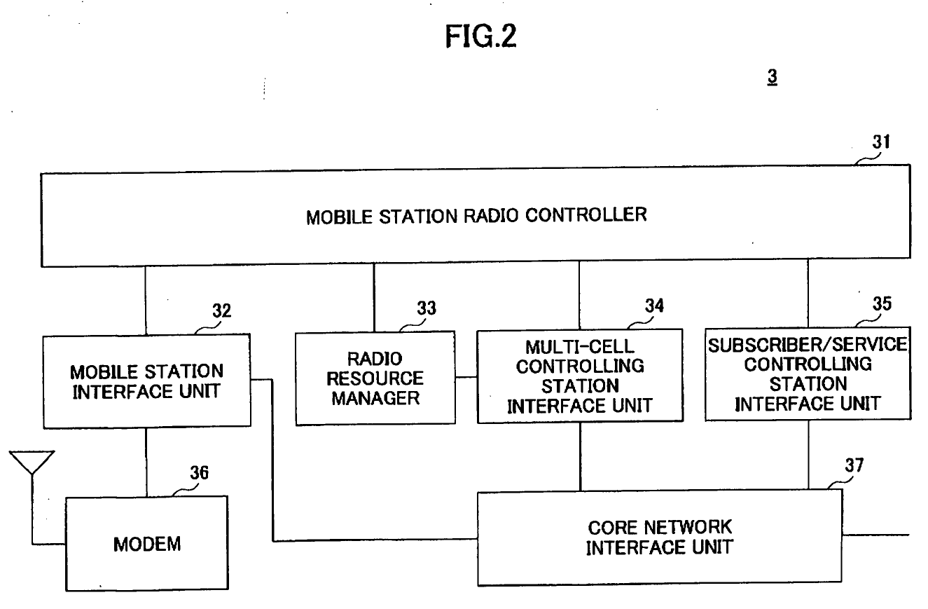

The base station 3 has a radio controlling function of controlling incoming and outgoing calls and hand-overs for each mobile station 2. The base station 3 has a protocol conversion function of converting protocols between the radio side (the mobile station 2 side) and the wired side (the core network 1 side). The base station 3 further has a communication function of transmitting/receiving information to and from the multi-cell controlling station 4 via the core network 1. The details are described below with reference to FIG. 2.

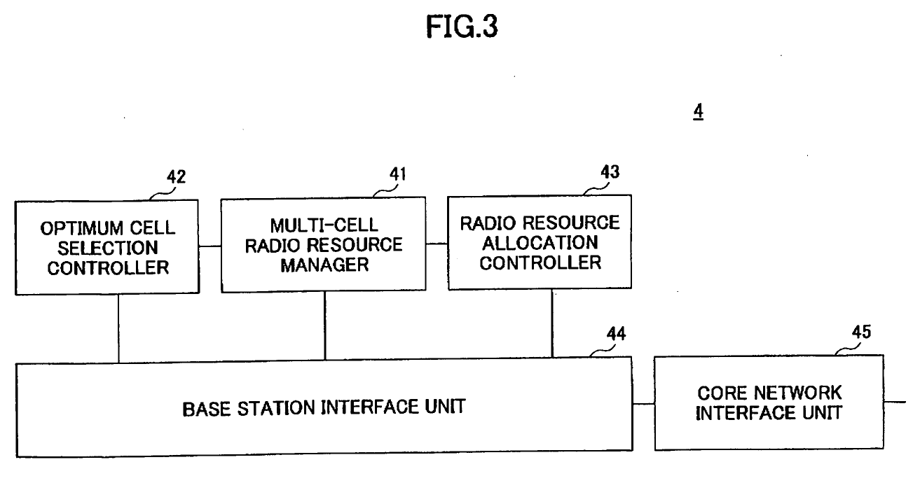

The multi-cell controlling station 4 has functions for managing radio resources of the plural base stations 3, selecting the optimum cell, and allocating radio resources. The details are described below with reference to FIG. 3.

The subscriber/service controlling station 5 has a function of transmitting and receiving information which is necessary for starting communications between the mobile station 2 and the network.

FIG. 2 is a block diagram of the base station 3 according to the embodiment of the present invention. The base station 3 shown in FIG. 3 comprises a mobile station radio controller 31, a mobile station interface 32, a radio resource manager 33, a multi-cell controlling station interface unit 34, a subscriber/service controlling station interface unit 35, a modem 36, and a core network interface unit 37.

The mobile station radio controller 31 has a function of managing, via the mobile station interface 32, radio control information (radio channel condition, authentication security information, charging traffic information, etc.) which is necessary for establishing a radio link for each mobile station 2. The mobile station radio controller 31 further has a controlling function of controlling hand-overs. Based on radio resource information managed by the radio resource manager 33, the mobile station radio controller 31 determines whether its own radio resource usage rate exceeds a predetermined threshold. If it is determined that its own radio resource usage rate is greater than the threshold (little available radio resources) when transmitting or receiving a call to or from a mobile station 2, the mobile station radio controller 31 communicates with the multi-cell controlling station 4 to receive instructions regarding the optimum radio cell to be allocated to the mobile station 2.

The mobile station interface 32 has a protocol conversion function of converting protocols of mainly a data link layer between the wired link and the radio link, according to instructions given by the mobile station radio controller 31.

The radio resource manager 33 has a function of managing the radio resource usage required for radio communication. The managed contents include resource information unique to radio access systems, and system usage conditions such as the number of connecting users and traffic amount. The resource information includes power resources, code resources, time resources, frequency resources, hardware resources, and so on. The radio resource manager 33 further may report radio resource status to the multi-cell controller 4, and dynamically change the allocation of various radio resources according to the instructions given by the multi-cell controlling station 4.

The multi-cell controlling station interface 34 has a function of performing protocol processing with the multi-cell controlling station 4. The mobile station radio controller 31 asks about the optimum cell for transmitting/receiving calls or performing hand-overs, via the multi-cell controlling station interface 34. Report of the radio resource status and the instruction to allocate radio resources are also done via the multi-cell controlling station interface 34.

The subscriber/service controlling station interface unit 35 has a function of performing protocol processing with the subscriber/service controlling station 5. Communications between the subscriber/service controlling station 5 and the mobile station 2 when sending/receiving calls is done via the subscriber/service controlling station interface unit 35.

The modem 36 has a function of converting between the wired signals and radio signals, and has a base band processing function, an RF band processing function, an amplifying function, and is connected to an antenna.

The core network interface unit 37 has a function of performing protocol processing of mainly a lower layer to communicate with the core network 1. Transmission/reception of signals to and from the multi-cell controlling station 4 and the subscriber/service controlling station 5 is done via the core network interface unit 37.

FIG. 3 is a block diagram of the multi-cell controlling station 4 according to the embodiment of the present invention. The multi-cell controlling station 4 shown in FIG. 3 comprises a multi-cell radio resource manager 41, an optimum cell selection controller 42, a radio resource allocation controller 43, a base station interface unit 44 and a core network interface 45.

The multi-cell radio resource manager 41 receives a report from a base station belonging thereto, and manages the radio resource usage.

When a mobile station 2 sends/receives calls and performs hand-overs, the optimum selection controller 42, at the request of the mobile station 2, selects the optimum cell and informs the base station 3 of the selected cell. The optimum cell is selected based on the radio resource usage conditions managed by the radio resource manager 33 of each base station 3.

The radio resource allocation controller 43 has a function of dynamically allocating radio resources when any base station 3 is short of radio resources.

The base station interface unit 44 has a function of performing protocol processing on signals transmitted/received between the multi-cell controlling station 4 and the base station 3.

The core network interface unit 45 has a function of performing protocol processing of mainly a lower layer to communicate with the core network.

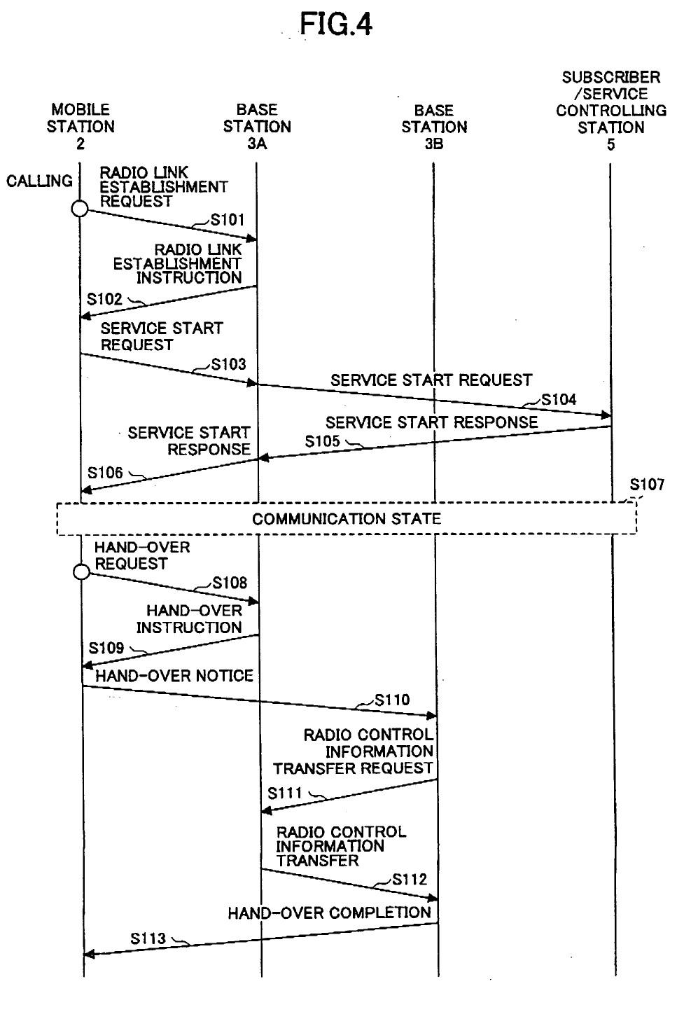

FIG. 4 is a sequence chart illustrating procedures for a call and a hand-over without the multi-cell controlling station 4 according to the embodiment of the present invention. Operations of each node, when establishing a call and performing a hand-over, are explained below with reference to FIG. 4.

First, when establishing a call, the mobile station 2 transmits a request for radio link establishment to the base station 3A at Step S101. The base station 3A receives the request for radio link establishment, designates its own radio cell, and transmits an instruction of radio link establishment to the mobile station 2 at step S102. In the conventional systems, such a radio link establishment procedure terminates at a radio controller arranged at a position higher than a base station. In the embodiment of the present invention, the radio link establishment terminates at the base station 3A.

Next, a request for starting service and a response thereto are transmitted and received between the mobile station 2 and the subscriber/service controlling station 5 via the base station 3A at steps S103˜S106. Since these request and response signals are not directly related to the radio link, they are just forwarded by the base station 3A. Although there is one round formed by the service start request at steps S103, S104 and the service start response at steps S105, S106 in this embodiment, there may be plural rounds including signals other than service related signals.

The above procedure is completed and communications are maintained at step S107.

Operations for a hand-over are explained below. It is assumed that the system utilizes the mobile station assisted hand-over in which the mobile station 2 notifies the base station 3 of plural candidate radio cells having high reception quality.

The base station 3A receives a hand-over request from the mobile station 2 triggered by a strong electric field detection at step S108, designates one base station 3B out of the candidate base stations, which base station 3B has the highest reception quality, and transmits a hand-over instruction to the mobile station 2 at step S109. It should be noted that this procedure also terminates at the base station 3A similar to the above radio link establishment request and instruction (steps S101, S102).

Then, the mobile station 2 sends a hand-over notice to the base station 3B at step S110. The base station 3B receives the hand-over notice and requires the original base station 3A to transfer radio control information necessary for continuing communications at step S111. The base station 3A transfers the radio control information to the base station 3B at step S112. The hand-over is completed at step S113. The radio control information includes on-going radio channel conditions, authentication security information, charging traffic information, etc., which are necessary for continuing the communications.

As mentioned above, according to the present invention, a mobile communication system may be established even without a multi-cell controlling station. Since the radio-related procedures such as the radio link establishment request/instruction (steps S101, S102), the hand-over request/instruction (steps S108, S109) and hand-over notice/completion (steps S110˜S113) terminate at nodes such as the base stations 3A, 3B nearest to the mobile station 2, the control delay becomes short.

However, in a case where the multi-cell controlling station is not arranged, it is impossible to select the optimum radio cell considering traffic congestion or dynamically allocate radio resources. Therefore, the above structure is suitable for mobile communication systems which utilize a single cell arrangement or have plenty of radio resources even in a multi-cell arrangement.

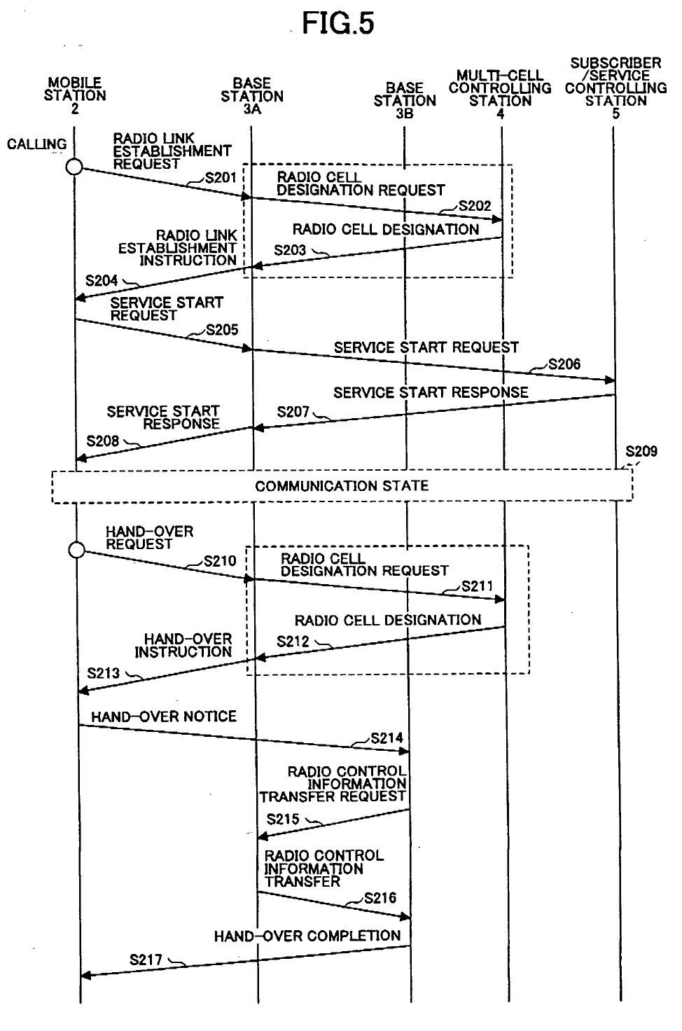

FIG. 5 is a sequence chart illustrating a calling procedure and a hand-over procedure with the multi-cell controlling station 4 according to another embodiment of the present invention.

The procedures shown in FIG. 5 are different from the procedures shown in FIG. 4 in steps (steps S202, S203, steps S211, S212) shown within broken line boxes. Radio cell designation requests and radio cell designation signals responding thereto are transmitted/received between the base station 3 and the multi-cell controlling station 4 in this embodiment.

In the procedures shown in FIG. 4 having no multi-cell controlling station, the base station 3A receives the radio link establishment request, designates its own radio cell, and directly sends the response to the mobile station 2. The base station 3a further receives the hand-over request, selects the base station having the highest reception quality, and directly sends the response to the mobile station 2.

On the other hand, in the procedures shown in FIG. 5, the base station 3A sends responses in accordance with instructions given by the multi-cell controlling station 4.

Therefore, the optimum radio cell can be selected and radio resources can be dynamically allocated by the multi-cell controlling station 4, in consideration of traffic congestion, to improve radio link capacity. However, communications with the multi-cell controlling station 4 make control delay longer. Accordingly, it is effective to ask (query) the multi-cell controlling station 4 only when traffic is congested and the radio resources become in short supply.

A procedure for querying the multi-cell controlling station 4, only when traffic congestion occurs, is explained below.

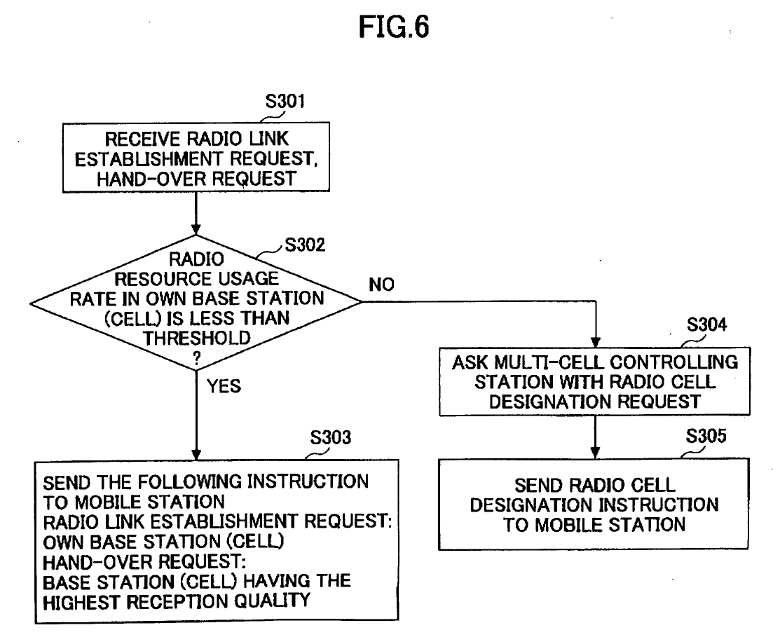

FIG. 6 is a flowchart illustrating a procedure in the base station 3 when receiving a request for radio link establishment or a request for a hand-over according to a further embodiment of the present invention.

In the procedure shown in FIG. 6, when the base station receives the request for radio link establishment or the request for a hand-over at step S301, it compares its own radio resource usage rate with a predetermined threshold to determine whether to ask the multi-cell controlling station 4 at step S302.

If the usage rate is less than the threshold (enough resources are left), it is not necessary to ask the multi-cell controlling station 4, and the procedure goes to S303. The base station designates its own base station in response to the radio link establishment request and selects the base station having the highest reception quality in response to the hand-over request.

On the other hand, if its own radio resource usage rate exceeds the predetermined threshold (there are not enough remaining radio resources), the procedure goes to S304. The base station asks the multi-cell controlling station and sends the mobile station 2 an instruction given by the multi-cell controlling station 4 at step S305.

According to this embodiment of the present invention, the multi-cell controlling station 4 is utilized only when there are not enough available radio resources, so that increasing the control delay can be avoided.

The present application is based on Japanese Priority Application No. 2005-018480 filed on Jan. 26, 2005 with the Japanese Patent Office, the entire contents of which are hereby incorporated by reference.

What is claimed is:

1. A mobile communication system for providing mobile communication service by radio to a mobile station, comprising:
a plurality of base stations having a function of controlling hand-overs and in-coming and out-going calls necessary for providing said mobile communication service.

2. The mobile communication system as claimed in claim 1, further comprising:
a multi-cell controlling station having a function of managing radio resources of the plural base stations forming radio cells and selecting an optimum one of the base stations, and a function of allocating the radio resources to the base stations.

3. The mobile communication system as claimed in claim 2, wherein;
at least a first one of said base stations has means for determining its own radio resource usage rate;
when said first one of said base stations controls the in-coming or out-going call or controls the hand-over, said first one of said base stations communicates with the multi-cell controlling station to select one of the base stations to be allocated if its own radio resource usage rate exceeds a predetermined threshold, and selects one of the base stations to be allocated without communicating with the multi-cell controlling station if its own radio resource usage rate is lower than the threshold.

4. The mobile communication system as claimed in claim 3, wherein:
said hand-over controlling is performed based on a mobile station assisted hand-over system in which the mobile station notifies the first one of the base stations of candidate radio cells having high reception quality.
